(19) United States
(12) Patent Application Publication
(10) Pub. No.: US 2011/0016518 A1
(43) Pub. Date: Jan. 20, 2011

(54) SYSTEM TO ENABLE A SINGLE SIGN-ON BETWEEN A DOCUMENT STORAGE SERVICE AND CUSTOMER RELATIONSHIP MANAGEMENT SERVICE

(76) Inventors: Hiroshi Kitada, Tuckahoe, NY (US); Lana Wong, Randolph, NJ (US)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/505,871

(22) Filed: Jul. 20, 2009

(51) Int. Cl. G06F 21/00

(52) U.S. Cl. 726/8

(57) ABSTRACT

Described herein is a method for producing a single sign-on between two network accessible software applications using a server apparatus having a processor and a computer readable medium. The method includes calling a new program interface using a first software application, initiating a handshake between a first software application adaptor and the first software application, sending authentication information from the first software application to the first software application adaptor, authenticating the authentication information using a second software application and returning a valid session ID from said second software application to said first software application via the first software application adaptor.

### BACKGROUND OF THE INVENTIONS

The present invention relates to a system and method of enabling a single sign-on between a Document storage service and Customer Relationship Management service.

Conventionally, when using a customer relationship management service such as salesforce.com™ in concert with a document storage service such as Document Mall™, authentication between the services has been difficult.

### SUMMARY OF THE INVENTIONS

Accordingly, the present inventions provide, inter alia, a method for producing a single sign-on between two network accessible software applications using a server apparatus having a processor and a computer readable medium, the method including the steps of calling a new program interface using a first software application, initiating a handshake between a first software application adaptor and the first software application, sending authentication information from said first software application to said first software application adaptor, authenticating said authentication information using a second software application, and returning a valid session ID from said second software application to said first software application via the first software application adaptor.

Also provided is a system having a single sign-on between two network accessible software applications. The system includes a first server apparatus having, a first network accessible software application, a processor and a computer readable medium. The first server apparatus includes an interface initialization unit that calls a new program interface using the first network accessible software application, a handshake unit that controls a handshake between a first software application adaptor and the first network accessible software application, an authentication unit that transmits authentication information from the first network accessible software application to the first software application adaptor, and a session reception unit that receives a valid session ID from the first software adaptor. Also included in the system is an adaptor server apparatus having the first software application adaptor, a processor and a computer readable medium. The adaptor server apparatus includes a new program interface request reception unit that receives a request for a new program interface from the first network accessible software application, a handshake unit that executes a handshake with the first network accessible software application in response to the reception of the request for the new program interface from the first network accessible software application, and an authentication unit that receives authentication information from the first network accessible software application, forwards the authentication information to a second network accessible software application, receives the valid session ID from the second network accessible software application and forwards the valid session ID to the first network accessible software application as a response to the new program interface request.

Also included in the system is a second server apparatus having, the second network accessible software application, a processor and a computer readable medium. The second server apparatus includes an authentication unit that authenticates a user using the authentication information received from the first software application adaptor and a valid session ID unit that generates a valid session ID when the authentication unit authenticates the user based on the received authentication information and sends the valid session ID to the first software application adaptor.

It is to be understood that both the foregoing general description of the invention and the following detailed description are exemplary, but are not restrictive, of the invention.

### BRIEF DESCRIPTION OF SEVERAL VIEWS OF THE DRAWINGS

Other objects, features and advantages of the present invention will become more apparent from the following detailed description when read in conjunction with the accompanying drawings, in which:

FIG. 1 is a block diagram showing data mapping between an exemplary Document storage service and an exemplary Customer Relationship Management service;

FIG. 2 is a block diagram showing an organization of several servers having network accessible software applications;

FIG. 3 is a block diagram showing an authorization and handshaking process between two network accessible software applications;

FIG. 4 is a flow diagram showing a method according to one embodiment of the present invention;

FIG. 5 is a flow diagram showing a processing according to one embodiment of the present invention;

FIG. 6 is a block diagram showing the process for creating a valid session id for use between the network accessible software applications;

FIG. 7 is a block diagram showing the interaction between two network accessible software applications and a user interface;

FIG. 8 shows an exemplary user interface which accesses information from two network accessible software applications; and

FIG. 9 is a hardware configuration of an apparatus according to an embodiment of the present invention.

### DETAILED DESCRIPTION OF THE INVENTIONS

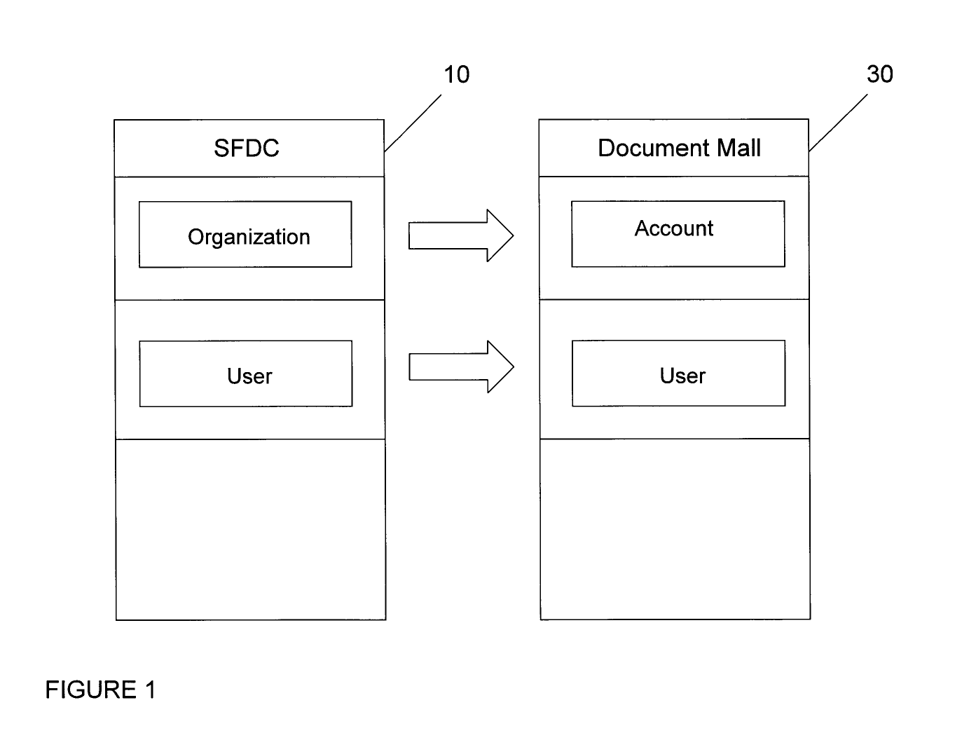

Referring now to the drawings wherein like reference numbers designate identical or corresponding parts throughout the several views and more particularly to FIG. 1 thereof, there is illustrated a data mapping that identifies the data relationships between data models of the exemplary Customer Relationship Management service and the exemplary Document storage service.

FIG. 1 illustrates that in order to execute a single sign-on which enables a user of a Customer Relationship Management service such as salesforce, for example, to access data on a document storage service such as Document Mall. As is shown in FIG. 1, during a one-time account creation process an Account is created in Document Mall which corresponds to an Organization in salesforce. Further, for each user in the salesforce organization, a user is created in Document Mall. In one embodiment of the invention the user's username in salesforce corresponds to the username in Document Mall.

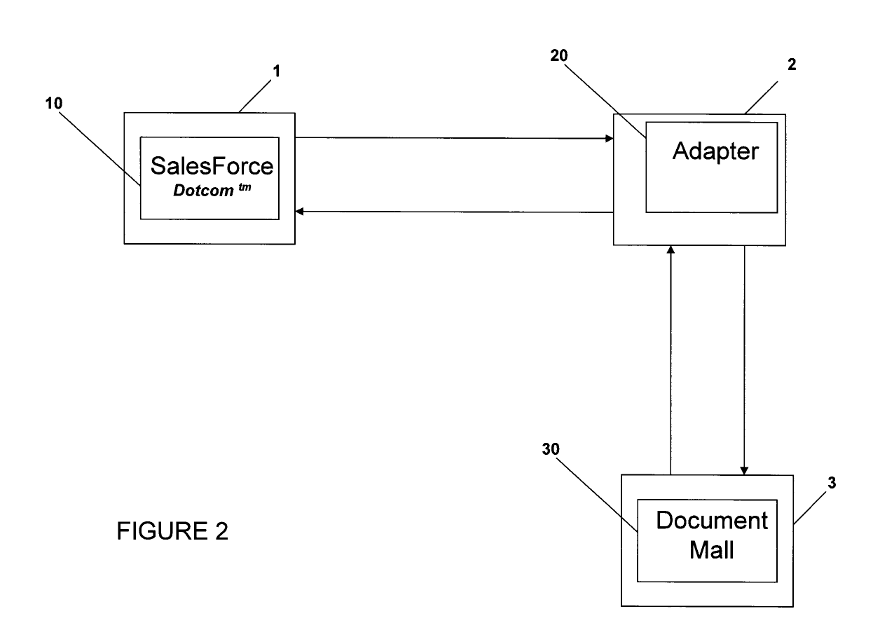

FIG. 2 illustrates the structure of the system in which a salesforce.com server 1 including a salesforce.com network accessible software application 10 is installed. The system also includes, for example, an adapter 20 and a server 2 on which the adapter 20 operates. The system also includes a Document Mall server 3 and a Document Mall network accessible software application 30 installed thereon. As can be seen from FIG. 1, the salesforce.com server 1 initially accesses the Document Mall server 3 via the adapter 20 and adapter server 2. The description of the salesforce.com network accessible software application 10 and the Document Mall network accessible software application 30 are exemplary, other types of network accessible software applications may also be used in the described system.

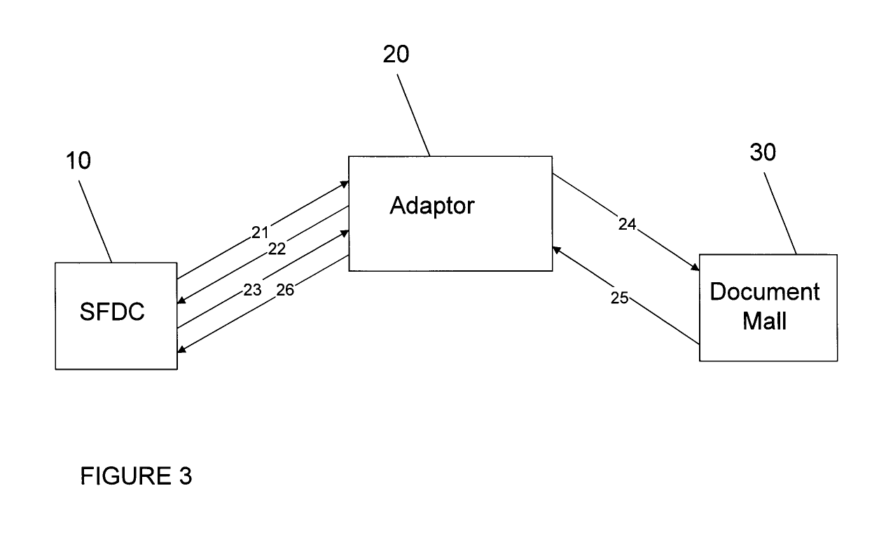

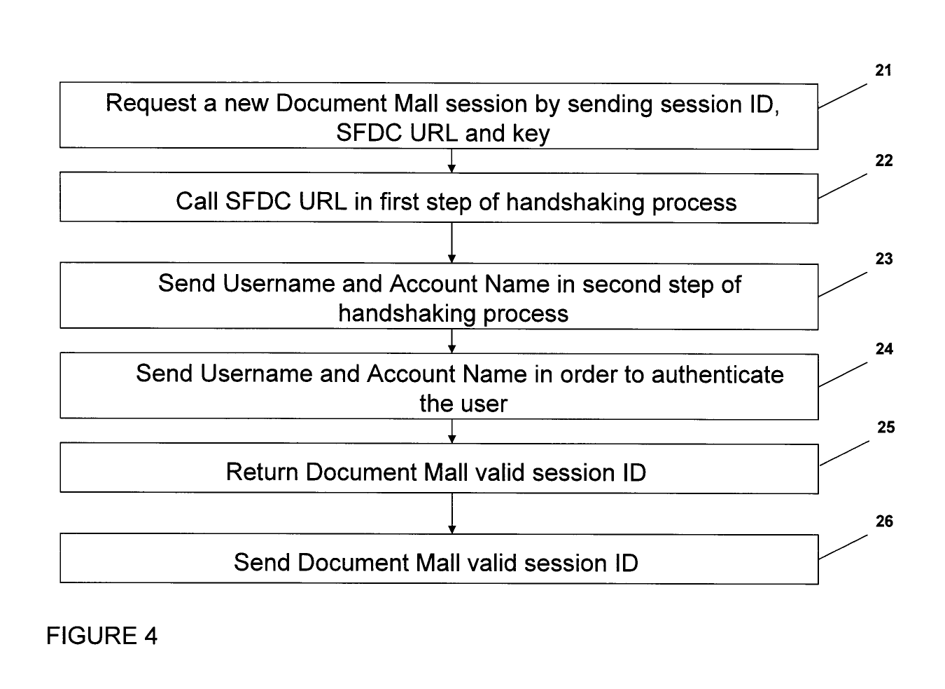

The present invention is related to a method and system enabling a single sign-on between a Document storage service and Customer Relationship Management service. FIGS. 3 and 4 provide an example of this method, beginning in FIG. 3 where the salesforce.com application 10, adapter 20 and Document Mall 30 are illustrated. Specifically, in FIG. 3 there is illustrated a flow process by which the salesforce.com 10 network accessible software application authenticates with the Document Mall server 30 such that the Document Mall 30 information can be accessed from the salesforce.com application 10. FIGS. 3 and 4 illustrate steps 21-26 which are provided for this process.

In step 21, the salesforce.com application 10 calls a new application programming interface (“API”) in order to request a new Document Mall 30 session. Included in this request are, at least, a SFDC session ID, a SFDC URL and a SFDC Key. Step 22 begins the process of handshaking between the salesforce.com application 10 and the adapter 20. Specifically, in step 22 the salesforce.com URL is called by the adaptor 20. In response, in step 23, the salesforce.com application 10 sends a Document Mall user name and account name to the adaptor 20 thus completing the handshaking process. As was noted above, the Document Mall user name and account name were previously created to match SFDC organization and user names. The adapter 20 then sends the received user name and account name to the Document Mall application 30 in step 24 in order to authenticate the session.

In response, in step 25, the Document Mall application 30 then returns a valid Document Mall session ID to the adapter 20 in step 25. The adapter 20 in step 26 then sends the valid Document Mall session ID to the salesforce.com application 10 as a response to the original request originated in step 21. By providing the valid Document Mall session ID to the salesforce.com application 10, the salesforce.com application 10 is able to use this valid session ID to access information from the Document Mall application 30.

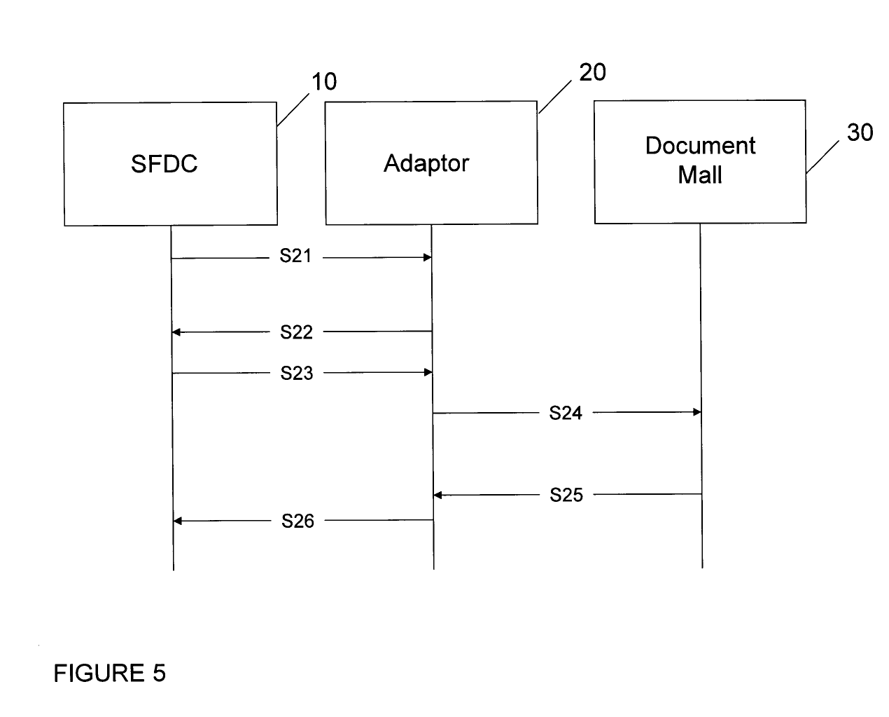

FIG. 5 shows a flow chart illustrating the timing of the process illustrated in FIGS. 3 and 4. Particularly, in one embodiment, in step 21, the SFDC 10 server sends a request to the adaptor 20 and not directly to the document mall server 10. Alternatively, the adaptor 20 could be part of the Document Mall server 30 or the Document Mall server 30 could perform the functionality of the adaptor 20.

In step 22, which is performed in response to the receipt of the request send in step 21, the adaptor 20 calls the salesforce.com URL. This is the first step of the handshaking process. In step 23, which performed in response to the receipt of the request in step 21, the salesforce.com application 10 sends a Document Mall user name and account name to the adaptor 20 thus completing the handshaking process.

Once the handshaking process is complete, the adaptor 20 sends the received user name and account name to the Document Mall application 30 in step 24 in order to authenticate the session.

In response, to the receipt of the user name and account name, the Document Mall server 30 sends a valid Document Mall Session ID to the adaptor 20 in step S25. Further, in response to receiving the user name and account name, the adapter 20, in step 26, sends the valid Document Mall session ID to the salesforce.com application 10 as a response to the original request originated in step 21.

The process shown in FIGS. 3-5 can be executed using at least one server apparatus having a processor and a computer readable medium. Specifically, this process is tied to the at least one server apparatus which is a particular machine configured to perform this process.

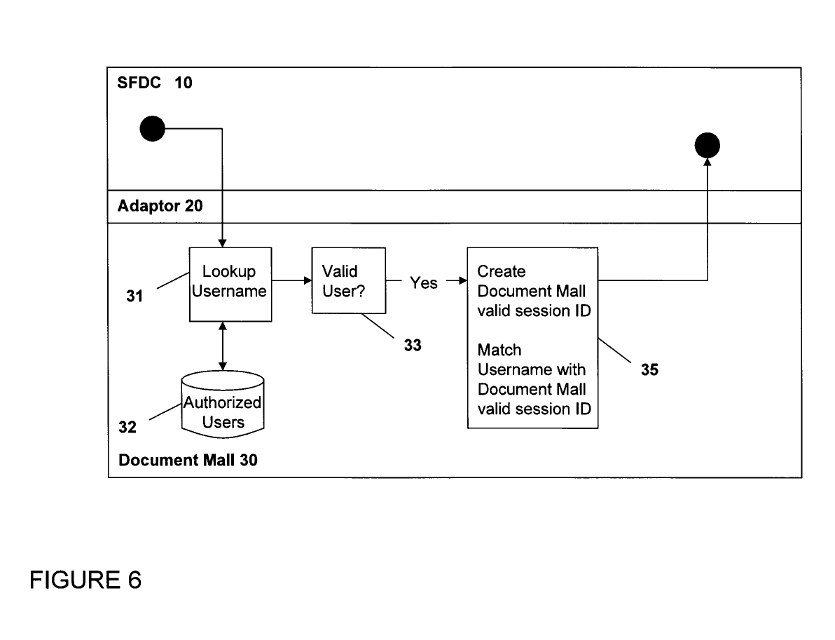

FIG. 6 shows a process whereby the Document Mall application 30 produces the session ID to be returned to the salesforce.com application 10 discussed above with regard to FIGS. 3-5.

As is shown in FIG. 6, the session ID generating process begins when the salesforce.com application 10 sends the user name and account name via the adapter 20 to the Document Mall application 30. In response to receiving this information the Document Mall application 30 in block 31 executes the user name lookup process. This lookup process accesses a database of authorized users 32 and, in block 33, determines whether or not the provided user information corresponds to a valid user. If it is determined that the provided information does not correspond to a valid user then the process is either terminated or alternatively a new user process can be performed. However, if it determined that the information provided corresponds to a valid user, e.g. “Yes”, then the flow proceeds to block 35 where the provided user ID is matched with a created Document Mall session ID which is then sent to the salesforce.com application 10.

Once a valid Document Mall session ID is returned to the salesforce.com application 10, the salesforce.com application 10 is able, as noted above, to access the information from the Document Mall application 30.

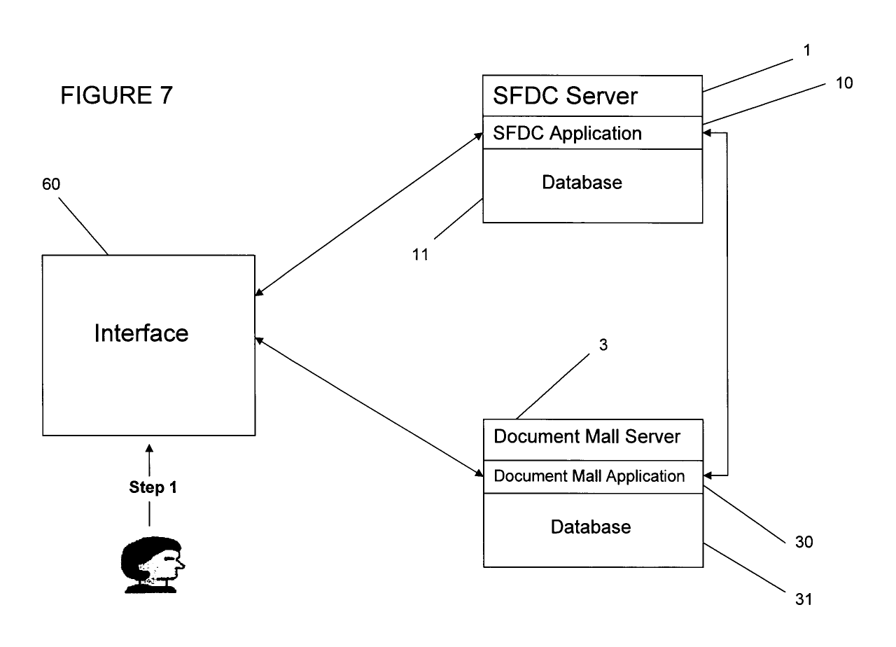

FIG. 7 illustrates a process whereby a user accesses the Document Mall information via a custom salesforce.com interface 60. In step 1 the user accesses the custom salesforce.com interface 60 which is connected to the salesforce.com application 10 via, for example, https. As is shown in FIG. 7 the salesforce.com interface 60 is, for example, a web browser which connects with the salesforce.com application 10 executed by the salesforce.com server 1 over https. Thus, once a user accesses the custom salesforce.com interface, the user is connected to the salesforce.com application 10 and the corresponding database 11. Additionally, assuming that the valid Document Mall session ID has been received by the salesforce.com application 10, the user will be able to access documents stored on the Document Mall server 30. Specifically, when the user, through the custom salesforce.com interface, accesses a document which is stored in a Document Mall database 31 or is controlled by the Document Mall application 30, as illustrated in FIG. 6, the Document Mall application 30 connects to the salesforce.com application 10. By this connection, the salesforce.com application 10 is notified of the access and is able to confirm that the request is in fact originating from the salesforce.com interface. The Document Mall application 30 then retrieves the information requested and, in step 4, sends the requested data back to the user via the custom salesforce.com interface 60. It should also be noted that the custom salesforce.com interface 60 knows what documents are available from the Document Mall application 30 because the salesforce.com application 10 and the Document Mall application 30 communicate. For instance, when a new document corresponding to an account or folder of the salesforce.com application 10 is added to the Document Mall database 31, this information is sent to the salesforce.com application 10 such that this application can update the list of available documents that is provided to the custom SFDC interface 60. This new document information can be sent at the time of entry of document in the Document Mall database 31 or when the SFDC application 10 accesses the folder of the account in question. Moreover, this information can be updated or a schedule or any some other time.

Thus, the custom salesforce.com interface 60 is able to access not only the salesforce.com server 1 and the salesforce.com application 10 executed thereon but also the Document Mall application 30 and the documents which are stored in the Document Mall database 31. Thus the salesforce.com server 1 and salesforce.com application 10 executed thereon are able to access the information controlled by the Document Mall application 30 using the valid Document Mall session ID.

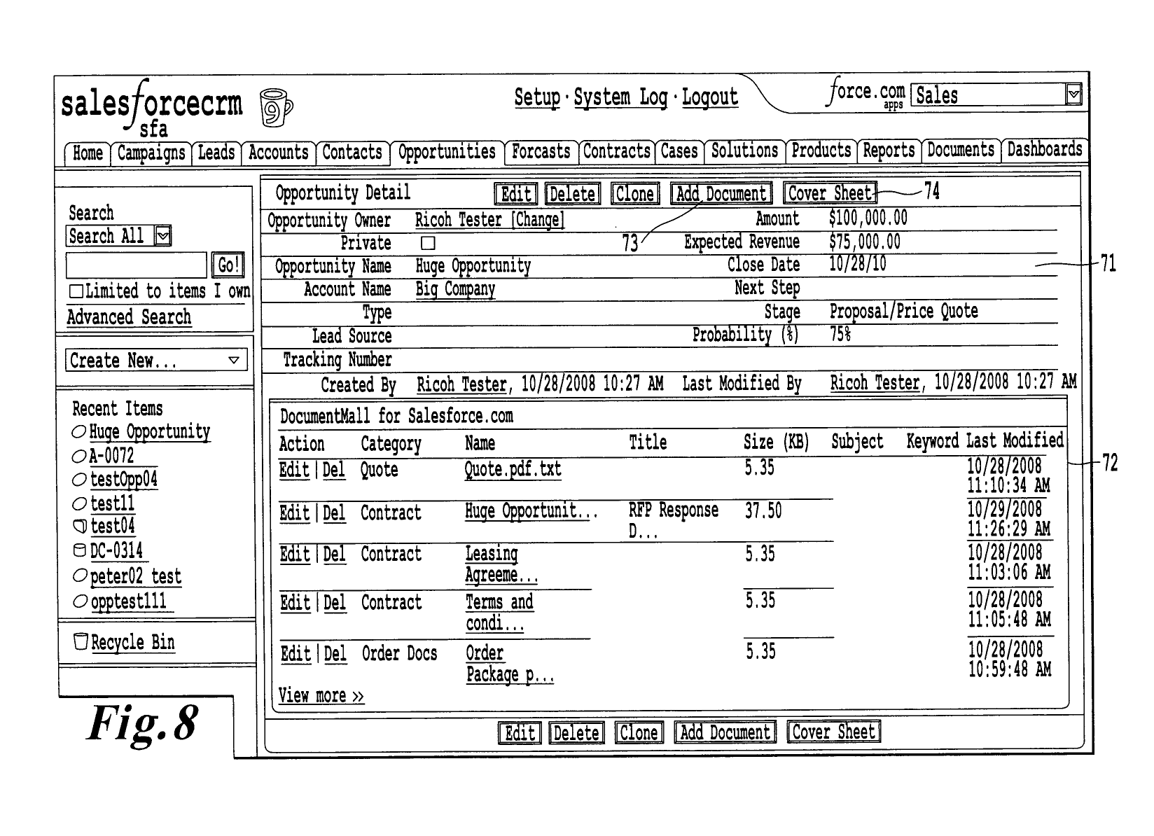

FIG. 8 illustrates an example of the custom salesforce.com interface 60 in which documents stored in the Document Mall database 31 are displayed. For example, in FIG. 7 there is shown an area 71 which displays the sales data that is retrieved from the database 11 of the salesforce.com server 1. Further, in area 72 there is displayed information regarding documents which are stored in the database 31 of the Document Mall server 3. In the example shown in FIG. 8, several documents such as “Quote.pdf.txt” “huge opportunity contract”, “leasing agreement”, “terms and conditions contract” and order documents are stored in the Document Mall server 3 and are accessible through the salesforce.com interface 60.

Further in FIG. 8 is shown an add document button 73 which allows the salesforce.com interface user to add a document to the Document Mall database 31 which is accessible through the custom salesforce.com interface 60.

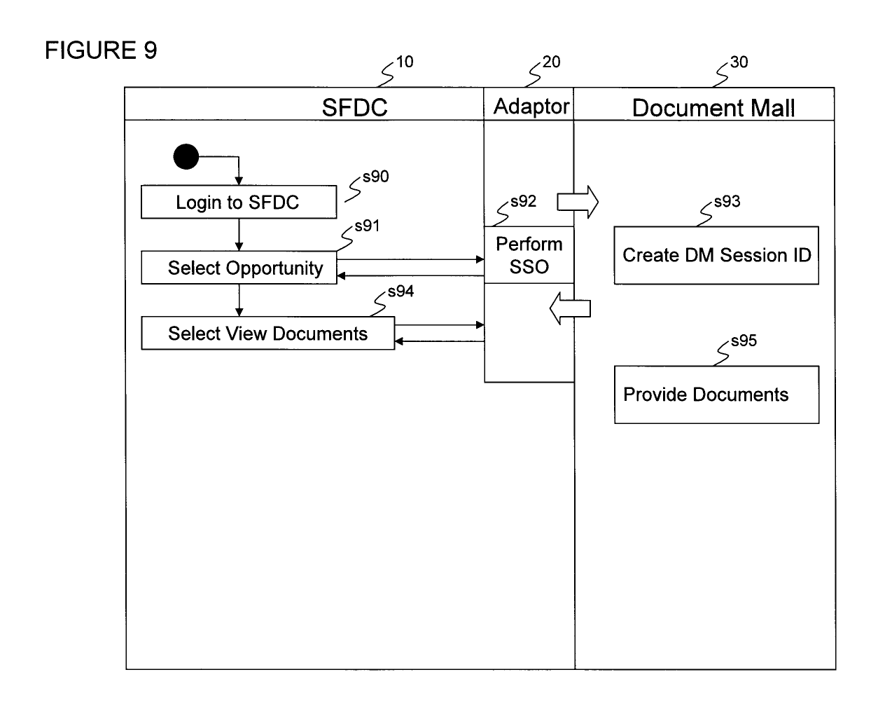

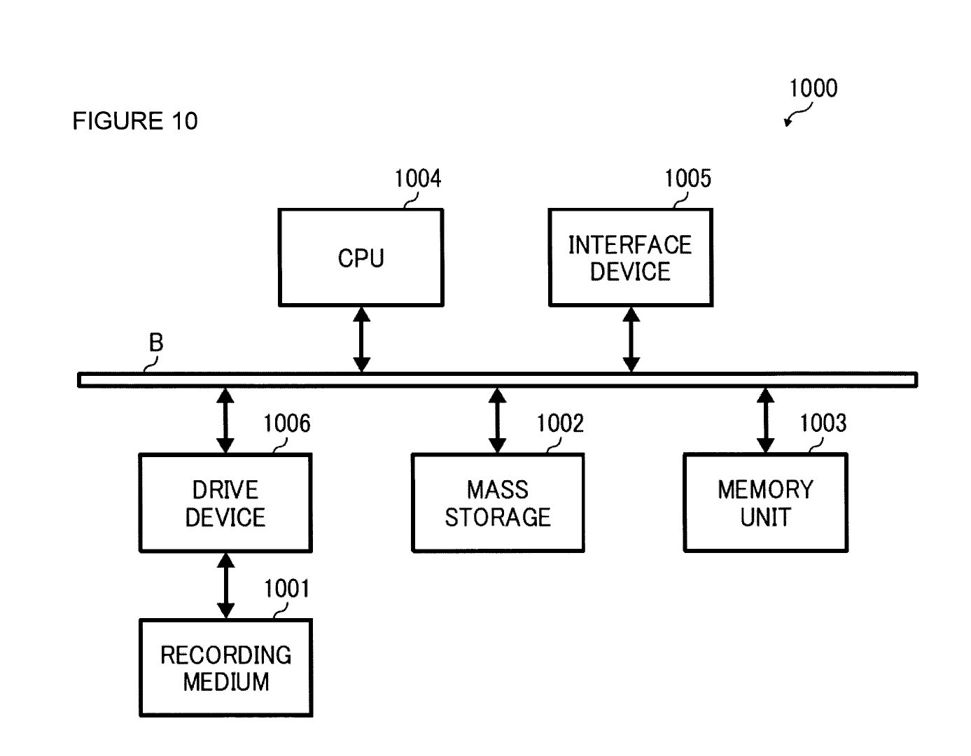

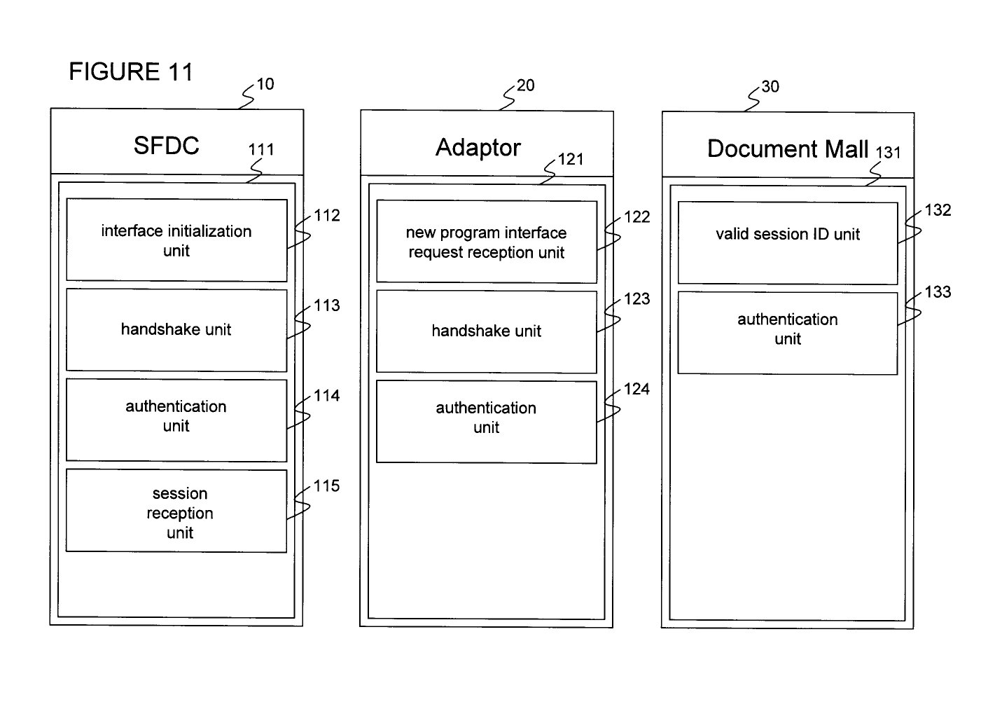

FIG. 9 illustrates a block diagram showing the interaction between the salesforce.com 10 server, the adaptor 20 and the Document Mall server 30. As is shown in FIG. 9, when a user logs into the salesforce.com application (S90) on the salesforce.com server 10 certain Opportunities associated with the user are displayed. When the user selects an Opportunity that includes Document Mall documents the system (S91) the single sign-on process (s92) is performed. Specifically, the process illustrated in FIGS. 3-5 is performed including the creation of a valid Document Mall session ID (S93). In addition, once the valid Document Mall session ID is received at the Salesforce.com server 10. A process for determining the list of files associated with the Opportunity/Account is performed. This process allows a list of available documents as is illustrated in FIG. 8.

Accordingly, when the user wishes to access the documents stored on the Document Mall server 30, the user can simply select one of the documents (S94) from the window illustrated in FIG. 8 which will execute a process by which the previously obtained valid Document Mall session ID is used to obtain document from the Document Mall server 30 (S95) via the adaptor 20. Thus, the user access to the documents on the Document Mall server 30 is also by way of the adaptor 20.

FIG. 10 illustrates a computer system 1000 upon which an embodiment of the present invention may be implemented. The computer system 1000 includes a bus B or other communication mechanism for communicating information, and a processor/CPU 1004 coupled with the bus B for processing the information. The computer system 1000 also includes a main memory/memory unit 1003, such as a random access memory (RAM) or other dynamic storage device (e.g., dynamic RAM (DRAM), static RAM (SRAM), and synchronous DRAM (SDRAM)), coupled to the bus B for storing information and instructions to be executed by processor/CPU 1004. In addition, the memory unit 1003 may be used for storing temporary variables or other intermediate information during the execution of instructions by the CPU 1004. The computer system 1000 may also further include a read only memory (ROM) or other static storage device (e.g., programmable ROM (PROM), erasable PROM (EPROM), and electrically erasable PROM (EEPROM)) coupled to the bus B for storing static information and instructions for the CPU 1004.

The computer system 1000 may also include a disk controller coupled to the bus B to control one or more storage devices for storing information and instructions, such as mass storage 1002, and drive device 1006 (e.g., floppy disk drive, read-only compact disc drive, read/write compact disc drive, compact disc jukebox, tape drive, and removable magneto-optical drive). The storage devices may be added to the computer system 1000 using an appropriate device interface (e.g., small computer system interface (SCSI), integrated device electronics (IDE), enhanced-IDE (E-IDE), direct memory access (DMA), or ultra-DMA).

The computer system 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1000 may also include a display controller coupled to the bus B to control a display, such as a cathode ray tube (CRT), for displaying information to a computer user. The computer system includes input devices, such as a keyboard and a pointing device, for interacting with a computer user and providing information to the processor. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system 1000 performs a portion or all of the processing steps of the invention in response to the CPU 1004 executing one or more sequences of one or more instructions contained in a memory, such as the memory unit 1003. Such instructions may be read into the memory unit from another computer readable medium, such as the mass storage 1002 or a removable media 1001. One or more processors in a multi-processing arrangement may also be employed to execute the sequences of instructions contained in memory unit 1003. In alternative embodiments, hard-wired circuitry may be used in place of or in combination with software instructions. Thus, embodiments are not limited to any specific combination of hardware circuitry and software.

As stated above, the computer system 1000 includes at least one computer readable medium 1001 or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other medium from which a computer can read.

Stored on any one or on a combination of computer readable media, the present invention includes software for controlling the computer system 1000, for driving a device or devices for implementing the invention, and for enabling the computer system 1000 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the CPU 1004 for execution. A computer readable medium may take many forms, including but not limited to, non-volatile media, and volatile media. Non-volatile media includes, for example, optical, magnetic disks, and magneto-optical disks, such as the mass storage 1002 or the removable media 1001. Volatile media includes dynamic memory, such as the memory unit 1003.

Various forms of computer readable media may be involved in carrying out one or more sequences of one or more instructions to the CPU 1004 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1000 may receive the data on the telephone line and use an infrared transmitter to convert the data to an infrared signal. An infrared detector coupled to the bus B can receive the data carried in the infrared signal and place the data on the bus B. The bus B carries the data to the memory unit 1003, from which the CPU 1004 retrieves and executes the instructions. The instructions received by the memory unit 1003 may optionally be stored on mass storage 1002 either before or after execution by the CPU 1004.

The computer system 1000 also includes a communication interface 1005 coupled to the bus B. The communication interface 1004 provides a two-way data communication coupling to a network that is connected to, for example, a local area network (LAN), or to another communications network such as the Internet. For example, the communication interface 1005 may be a network interface card to attach to any packet switched LAN. As another example, the communication interface 1005 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1005 sends and receives electrical, electromagnetic or optical signals that carry digital data streams representing various types of information.

The network typically provides data communication through one or more networks to other data devices. For example, the network may provide a connection to another computer through a local network (e.g., a LAN) or through equipment operated by a service provider, which provides communication services through a communications network. The local network and the communications network use, for example, electrical, electromagnetic, or optical signals that carry digital data streams, and the associated physical layer (e.g., CAT 5 cable, coaxial cable, optical fiber, etc). The signals through the various networks and the signals on the network and through the communication interface 1005, which carry the digital data to and from the computer system 1000 maybe implemented in baseband signals, or carrier wave based signals. The baseband signals convey the digital data as un-modulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as un-modulated baseband data through a “wired” communication channel and/or sent within a predetermined frequency band, different than baseband, by modulating a carrier wave. The computer system 1000 can transmit and receive data, including program code, through the network and the communication interface 1005. Moreover, the network may provide a connection to a mobile device such as a personal digital assistant (PDA) laptop computer, or cellular telephone.

In addition, as is shown in FIG. 11 each of the salesforce.com server 10, the adaptor server 20 and the Document Mall server 30, includes at least one processor.

The processor 111 in the salesforce.com server 10 is configured to have, at least, an interface initialization unit 112, a handshake unit 113, an authentication unit 114 and a session reception unit 115.

The interface initialization unit 112 is configured to call a new program interface using the first network accessible software application. The handshake unit 113 is configured to control a handshake between a first software application adaptor and the first network accessible software application. The authentication unit 114 is configured to transmit authentication information from said first network accessible software application to said first software application adaptor. The session reception unit 115 is configured to receive a valid session ID from the first software adaptor.

The processor 121 in the adaptor server 20 is configured to have, at least, a new program interface request reception unit 122, a handshake unit 123 and an authentication unit 124.

The new program interface request reception unit 122 is configured to receive a request for a new program interface from the first network accessible software application. The handshake unit 123 is configured to execute a handshake with the first network accessible software application in response to the reception of the request for the new program interface from the first network accessible software application. The authentication unit 124 is configured to receive authentication information from said first network accessible software application, forward the authentication information to a second network accessible software application, receive the valid session ID from the second network accessible software application and forward the valid session ID to the first network accessible software application as a response to the new program interface request.

The processor 131 in the Document Mall server 30 is configured to have, at least, a valid session ID unit 132 and an authentication unit 133.

The authentication unit 133 configured to authenticate a user using the authentication information received from the first software application adaptor. The valid session ID unit 132 configured to generate a valid session ID when the authentication unit 133 authenticates the user based on the received authentication information and send the valid session ID to the first software application adaptor.

The present invention is not limited to the specifically disclosed embodiments, and variations and modifications may be made without departing from the scope of the present invention.

What is claimed is:

1. A method for producing a single sign-on between two network accessible software applications using a server apparatus having a processor and a computer readable medium comprising:
calling a new program interface using a first software application;
initiating a handshake between a first software application adaptor and the first software application;
sending authentication information from said first software application to said first software application adaptor;
authenticating said authentication information using a second software application; and
returning a valid session ID from said second software application to said first software application via the first software application adaptor.

2. The method for producing a single sign-on according to claim 1,
wherein the calling further includes sending program interface parameters, the program interface parameters including a first software application session ID, a first software application URL and a first software application key.

3. The method for producing a single sign-on according to claim 1 wherein initiating the handshake between the first software application adaptor and the first software application includes the first software application adaptor calling a URL corresponding to the first software application.

4. The method for producing a single sign-on according to claim 1, further comprising:
calling a new program interface using a first software application in response to selection of an object in the first software application.

5. The method for producing a single sign-on according to claim 1, further comprising:
accessing an object on the second software application using the valid session ID returned from said second software application to said first software application via the first software application adaptor.

6. The method for producing a single sign-on according to claim 1, wherein the object is a document stored on the second software application.

7. The method for producing a single sign-on according to claim 4, further comprising:
calling a new program interface using a first software application only a first time an object in the first software application is selected in a session of the first software application.

8. The method for producing a single sign-on according to claim 1, further comprising:
creating authentication information for said second software application based on authentication information of said first software application.

9. The method for producing a single sign-on according to claim 8, wherein the authentication information of the second software application includes an account name and a user name.

10. A system having a single sign-on between two network accessible software applications, the system comprising:
a first server apparatus having, a first network accessible software application, a processor and a computer readable medium, the first server apparatus including:
an interface initialization unit configured to call a new program interface using the first network accessible software application;
a handshake unit configured to control a handshake between a first software application adaptor and the first network accessible software application;
an authentication unit configured to transmit authentication information from said first network accessible software application to said first software application adaptor;
a session reception unit configured to receive a valid session ID from the first software adaptor;
an adaptor server apparatus having the first software application adaptor, a processor and a computer readable medium, the adaptor server apparatus including:
a new program interface request reception unit configured to receive a request for a new program interface from the first network accessible software application;
a handshake unit configured to execute a handshake with the first network accessible software application in response to the reception of the request for the new program interface from the first network accessible software application;
an authentication unit configured to receive authentication information from said first network accessible software application, forward the authentication information to a second network accessible software application, receive the valid session ID from the second network accessible software application and forward the valid session ID to the first network accessible software application as a response to the new program interface request;
a second server apparatus having, the second network accessible software application, a processor and a computer readable medium, the second server apparatus including:
an authentication unit configured to authenticate a user using the authentication information received from the first software application adaptor; and
a valid session ID unit configured to generate a valid session ID when the authentication unit authenticates the user based on the received authentication information and send the valid session ID to the first software application adaptor.

11. A computer readable storage medium having stored thereon instruction for performing a method for producing a single sign-on between two network accessible software applications the method comprising:
calling a new program interface using a first software application;
initiating a handshake between a first software application adaptor and the first software application;
sending authentication information from said first software application to said first software application adaptor;
authenticating said authentication information using a second software application; and
returning a valid session ID from said second software application to said first software application via the first software application adaptor.

12. The computer readable medium according to claim 11,
wherein the calling further includes sending program interface parameters, the program interface parameters including a first software application session ID, a first software application URL and a first software application key.

13. The computer readable medium according to claim 11, wherein initiating the handshake between the first software application adaptor and the first software application includes the first software application adaptor calling a URL corresponding to the first software application.

14. The computer readable medium according to claim 11, further comprising:
calling a new program interface using a first software application in response to selection of an object in the first software application.

15. The computer readable medium according to claim 11, further comprising:
accessing an object on the second software application using the valid session ID returned from said second software application to said first software application via the first software application adaptor.

16. The computer readable medium according to claim 11, wherein the object is a document stored on the second software application.

17. The computer readable medium according to claim 14, further comprising:
calling a new program interface using a first software application only a first time an object in the first software application is selected in a session of the first software application.

18. The computer readable medium according to claim 11, further comprising:
creating authentication information for said second software application based on authentication information of said first software application.

19. The computer readable medium according to claim 18, wherein the authentication information of the second software application includes an account name and a user name.
